(19) United States
(12) Patent Application Publication
(10) Pub. No.: US 2023/0364769 A1
(43) Pub. Date: Nov. 16, 2023

(54) POWER TOOL AND A DEPTH ADJUSTMENT MECHANISM THEREFOR

(71) Applicant: Black & Decker, Inc., New Britain, CT (US)

(72) Inventors: Arthur LAUER, Frankfurt (DE); Markus ROMPEL, Runkel / Schadeck (DE); Benjamin SCHMIDT, Mainz (DE); Marco KUGLER, Waldbrunn-Haused (DE)

(21) Appl. No.: 18/222,793

(22) Filed: Jul. 17, 2023

Related U.S. Application Data
(63) Continuation of application No. PCT/EP2022/050058, filed on Jan. 4, 2022.

(51) Int. Cl. B25F 5/00; B27C 5/10

(52) U.S. Cl. CPC B25F 5/003; B27C 5/10; B23C 2255/08

(57) ABSTRACT

A power tool including a housing and a motor assembly arranged to rotate a cutting tool. The motor is mounted in the housing. At least one guide post is slidably mounted to the housing. The power tool includes a base fixed to the guide post. A depth adjustment mechanism is arranged to adjust the distance the cutting tool projects through the base. The depth adjustment mechanism has a depth rod adjustably mounted to the housing and arranged to engage the base when the housing is plunged towards the base. The depth adjustment mechanism also has a depth adjustment knob mechanically coupled to the depth rod and moving the depth rod with respect to the housing. The depth adjustment mechanism further has a locking knob for selectively locking the depth rod. One of the depth adjustment knob and the locking knob at least partially is nested within the other.

### CROSS-REFERENCE TO RELATED APPLICATIONS

The present application is a continuation of international application PCT/EP2022/050058, filed on Jan. 4, 2022, which is herein incorporated by reference in its entirety.

### BACKGROUND OF THE INVENTION

The present invention relates to a power tool and a depth adjustment mechanism therefor and in particular a plunge router and an associated depth adjustment mechanism.

A power tool such as a router may be utilized by tradesmen, craftsmen, hobbyists and other users to perform various tasks. For instance, a router may be used to perform intricate cutting projects, such as decorative profiles and trimming laminates on the edges or perimeters of a workpiece. A router also may be utilized to form grooved areas in woodworking and other material as well as to remove excess material on workpieces. Routers may utilize various types of cutting tools or router bits in order to perform these and other types of tasks.

A router normally comprises one or more handles allowing the user to grip the router during operation. This means that the user can manoeuvre the router with respect to the workpiece. It is known for a router to vary the height of the cutting tool with respect to the workpiece during operation. This is also known as a “plunge” mode of operation. The plunge mode allows the user to plunge the cutting tool of the router into the workpiece in order to cut a hole in the middle of the workpiece. The user may select how far the cutting tool projects from the base of the router in the plunge mode using a lockable depth adjustment mechanism.

One router with such a lockable depth adjustment mechanism is shown in U.S. Pat. No. 6,568,887. The lockable depth adjustment mechanism comprises a post lock mechanism having a lever for locking the depth adjustment mechanism. When the lever is rotated, a gear lock screw presses a nut against the gear and locks the gear against the housing of the router.

A problem with this arrangement is that the depth adjustment mechanism and locking lever take up space on the housing requiring that the router is wider. Furthermore, the locking lever can be difficult for a user to easily release whilst gripping the handles of the router.

Another problem with the router of U.S. Pat. No. 6,568,887 is that the locking arrangement urges a force against a gear wheel of the depth adjustment mechanism pushing the gear wheel against the housing. This can warp the housing and damage the gear wheel over time. This means the efficacy of the locking arrangement of the depth adjustment mechanism can decrease over time.

### SUMMARY OF THE INVENTION

Examples of the present disclosure aim to address the aforementioned problems.

According to an aspect of the present disclosure there is a power tool comprising:
a housing; a motor assembly arranged to rotate a cutting tool, the motor being mounted in the housing; at least one guide post slidably mounted to the housing; a base fixed to the at least one guide post; and a depth adjustment mechanism arranged to adjust the distance the cutting tool projects through the base, the depth adjustment mechanism comprises: a depth rod adjustably mounted to the housing and arranged to engage the base when the housing is plunged towards the base; a depth adjustment knob mechanically coupled to the depth rod being arranged to move the depth rod with respect to the housing; a locking knob for selectively locking the depth rod; wherein one of the depth adjustment knob and the locking knob is at least partially nested within the other of the depth adjustment knob and the locking knob.

Optionally, the locking knob is nested within the depth adjustment knob.

Optionally, locking knob is mounted on a rotatable shaft.

Optionally, the rotatable shaft is coupled to a locking mechanism moveable between a locked position and an unlocked position.

Optionally, the locking mechanism comprises a clamping element arranged to urge against the depth rod in the locked position.

Optionally, the clamping element is arranged to urge against the depth rod in a direction towards the locking knob.

Optionally, the clamping element is pivotally mounted and arranged to move between a first position engaging the depth rod when the locking mechanism is in the locked position and a second position remote from the depth rod when the locking mechanism is in the unlocked position.

Optionally, the depth adjustment knob comprises a sleeve portion mountable on at least a portion of the locking knob.

Optionally, the sleeve portion is mountable on the rotatable shaft.

Optionally, the sleeve portion comprises a pinion engageable with a reciprocal rack mounted on the depth rod.

Optionally, the depth adjustment mechanism comprises a rotatable scale collar.

Optionally, the rotatable scale collar is rotatable with respect to the depth adjustment knob.

Optionally, the housing comprises a scale mark for aligning with the rotatable scale collar.

Optionally, the depth adjustment knob comprises an indexing mechanism configured to index rotation of the depth adjustment knob.

Optionally, the indexing mechanism comprises a circumferential indexing surface mounted on a portion of the depth adjustment knob.

Optionally, the indexing mechanism comprises a spring biased pin arranged to engage the circumferential indexing surface.

Optionally, the power tool is a plunge router.

According to another aspect of the present disclosure there is a depth adjustment mechanism for a power tool for adjusting a distance a cutting tool projects through a base of the power tool, the depth adjustment mechanism comprising: a depth rod adjustably mounted to a housing and arranged to engage the base when the housing is plunged towards the base; a depth adjustment knob mechanically coupled to the depth rod being arranged to move the depth rod with respect to the housing; a locking knob for selectively locking the depth rod; wherein one of the depth adjustment knob and the locking knob is at least partially nested within the other of the depth adjustment knob and the locking knob.

According to yet another aspect of the present disclosure there is a power tool comprising: a housing; a motor assembly arranged to rotate a cutting tool, the motor being mounted in the housing; at least one guide post slidably mounted to the housing; a base fixed to the at least one guide post; and a depth adjustment mechanism arranged to adjust the distance the cutting tool projects through the base, the depth adjustment mechanism comprises: a depth rod adjustably mounted to the housing and arranged to engage the base when the housing is plunged towards the base; a depth adjustment knob mechanically coupled to the depth rod being arranged to move the depth rod with respect to the housing; a locking mechanism moveable between a locked position and an unlocked position for selectively locking the depth rod; wherein the locking mechanism comprises a clamping element configured to clamp against the depth rod when the locking mechanism is in the locked position.

Optionally, the clamp urges against the depth rod in a direction towards the depth adjustment knob when the locking mechanism is in the locked position.

### BRIEF DESCRIPTION OF THE DRAWINGS

Various other aspects and further examples are also described in the following detailed description and in the attached claims with reference to the accompanying drawings, in which:

FIG. 1 shows a perspective view of a power tool according to an example;

FIG. 2 shows a close-up perspective view of a power tool according to an example;

FIG. 3 shows a close-up partial cut-away perspective view of power tool according to an example;

FIG. 4 shows a partial cross-sectional side view along the axis B-B of a depth adjustment mechanism according to an example;

FIG. 5 shows a partial cross-sectional plan view along the axis C-C of a depth adjustment mechanism according to an example;

FIG. 6 shows an exploded perspective view of a depth adjustment mechanism according to an example; and

FIG. 7 shows a perspective view of a depth adjustment mechanism according to an example.

### DETAILED DESCRIPTION OF THE INVENTION

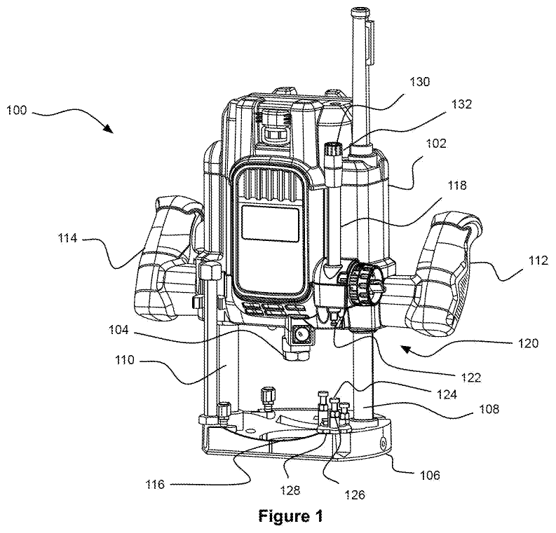

FIG. 1 shows a front view of a power tool 100 according to an example. The power tool 100 as shown in FIG. 1 is a router 100. Hereinafter, the power tool 100 will be referred to as a router 100, but in other examples any other type of power tool can be used such as a plunge saw, a drill, a multitool, or an oscillating tool mounted on a plunge base.

The router 100 comprises a housing 102. The housing 102 comprises a clam shell type construction having two halves which are fastened together. The halves of the housing 102 are fastened together with screws but in alternative examples any suitable means for fastening the housing 102 together may be used such as glue, clips, bolts and so on. For the purposes of clarity, the fastenings in the housing 102 are not shown.

A motor (not shown) is mounted in the housing 102 for driving a collet 104. A cutting tool (not shown) can be mounted in the collet 104 for engaging a workpiece (not shown). In some examples, the cutting tool is a router bit. For the purposes of clarity, the router bit is not shown in FIG. 1. In other examples, the cutting tool can be a saw bit, a drill bit or any other suitable cutting tool.

As shown in FIG. 1, the router 100 comprises a base 106 for engaging the workpiece. The base 106 comprises an aperture 116 through which the cutting tool projects. The base 106 is mounted to the housing 102 via first and second guide posts 108, 110. The first and second guide posts 108, 110 are slidably mounted to the housing 102 for adjusting the relative distance of the base 106 from the collet 104. In some examples, the first and second guide posts 108, 110 are removeable. This means that the router 100 can be used without the base 106 engaging the workpiece.

The housing 102 comprises a first and second handle 112, 114 for the user to grip during operation. The first handle 112 comprises a main trigger switch (not shown) for operating the router 100. In some examples, the first handle 112 also comprises a lock button (not show) for selectively locking the main trigger switch into an “ON” status. This means that the user does not have to constantly keep pressure maintained on the main trigger switch during operation of the router 100. In some examples, the main trigger switch can be replaced with a momentary switch (not shown).

The motor is electrically connected to an electric power source. In some examples, the electric power source is a mains electrical supply. In some other examples, the electrical power source is a battery (not shown). The battery can be removably mountable to the housing 102 or integral to the housing 102. In some examples, the router 100 can be powered either from both a battery source and/or a mains electrical supply.

The router 100 as shown in FIG. 1 is a plunge router. Accordingly, the router 100 can be selectively operated in different modes. In a first mode, the router 100 is in a locked position. In the locked position, the first and second guide posts 108, 110 are fixed with respect to the housing 102. This means that the housing 102 and the collet 104 are fixed with respect to the base 106. Accordingly, the cutting tool can be maintained at a set height above the workpiece. This means that the user of the router 100 can select how far the cutting tool projects through the aperture in the base 106.

In a second mode, the router 100 is in an unlocked position or “plunge” mode. In the unlocked position the first and second guide posts 108, 110 are slidable with respect to the housing 102. This means that the user can push down on the first and second handles 112, 114 and the first and second guide posts 108, 110 slide into or through the housing 102. In this way, the distance between the base 106 and the housing 102 can be adjusted. This means that the user can position the router 100 above the workpiece and then push the housing 102 towards the workpiece and the cutting tool plunges into the workpiece.

The router 100 comprises a depth adjustment mechanism 120 arranged to adjust the distance the cutting tool projects through the base 106. For example, when the router 100 is in the plunge mode, the user is able to push the housing 102 and the cutting tool towards the base 106. The base 106 comprises an aperture 116 for receiving the cutting tool. This means that when the base 106 engages the surface of a workpiece (not shown), the cutting tool can project through the aperture 116 and engage the workpiece. The depth of cut made by the cutting tool in the workpiece depends on the setting of the depth adjustment mechanism 120.

The depth adjustment mechanism 120 comprises a depth rod 118. The depth rod 118 is mounted to the housing 102 and is the position of the depth rod 118 is adjustable with respect to the housing 102. Adjustment of the depth rod 118 will be discussed in further detail below.

The depth rod 118 comprises a depth stop 122 at an end of the depth rod 118. In some examples, the depth stop 122 is a flat surface, facing towards the base 106. The depth stop 122 is arranged to engage a reciprocal base depth stop 124. The reciprocal base depth stop 124 is mounted on the base 106 and fixed with respect to the base 106. The reciprocal base depth stop 124 is a flat surface facing towards the housing 102 from the base 106. In this way, when the housing 102 is plunged towards the base 106, the flat surfaces of the depth stop 122 and the reciprocal base depth stop 124 engage and abut each other.

When the depth stop 122 and the reciprocal base depth stop 124 engage, the housing 102 and the cutting tool cannot move any further towards the base 106. This means that the depth adjustment mechanism 120 limits the extent that the housing 102 and the cutting tool can move towards the base 106. As mentioned previously, this controls the amount the cutting tool projects through the aperture 116.

In some examples, reciprocal base depth stop 124 is adjustable. This means that the reciprocal base depth stop 124 can be moved with respect to the base 106. The reciprocal base depth stop 124 can optionally comprise a screw thread and be threaded into a reciprocal locking nut 126 and bore in the base 106. The reciprocal locking nut 126 can be loosened to adjust the distance the reciprocal base depth stop 124 projects towards the housing 102 from the base 106. Optionally, in some other examples the reciprocal base depth stop 124 is fixed with respect to the base 106 and is not adjustable.

In some examples, the reciprocal base depth stop 124 is a single element mounted on the base 106. However, alternatively, as shown in FIG. 1, a plurality of reciprocal base depth stops 124 are mounted on a revolving platform 128. For the purposes of clarity only one reciprocal base depth stop 124 has been labelled in FIG. 1. The plurality of reciprocal base depth stops 124 each project towards the housing 102 from the base 106 by a different distance. This means that the plurality of reciprocal base depth stops 124 can provide a series of different predetermined depth settings for the cutting tool. For example, FIG. 1 shows three separate reciprocal base depth stops 124 each projecting a different amount from the base 106. In some examples, the plurality of reciprocal base depth stops 124 could respectively provide cutting tool settings where the cutting tool projects through the aperture 116 by e.g., 1 mm, 3 mm and 5 mm. However, the user is able to adjust the plurality of reciprocal base depth stops 124 to any depth adjustment needed.

The revolving platform 128 is arranged to rotate with respect to the base 106. This means that the plurality of reciprocal base depth stops 124 can each be selectively rotated into position such that it is aligned with the depth rod 118 and depth stop 122.

The router 100 in some examples can optionally comprise a fine depth adjustment mechanism 130. The fine depth adjustment mechanism 130 can adjust the position of the depth rod 118 and the depth stop 122 with respect to the housing 102. The fine depth adjustment mechanism 130 can adjust the depth rod 118 and the depth stop 122 with respect to the housing by a smaller increment than the depth adjustment mechanism 120. In some examples, the fine depth adjustment mechanism 130 comprises a fine adjustment knob 132 threaded into one end of the depth rod 118. Rotation of the fine adjustment knob 132 causes a small movement of the depth rod 118 and the depth stop 122 towards or away from the base 106.

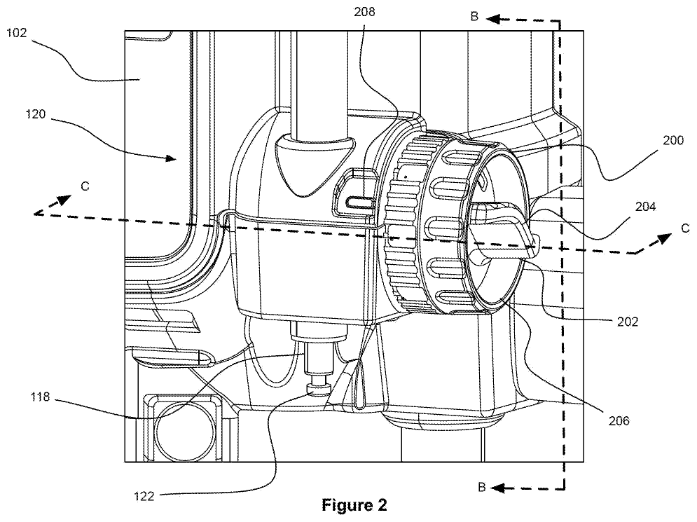

The depth adjustment mechanism 120 will now be discussed in more detail with respect to FIG. 2. FIG. 2 shows a close-up perspective view of the router 100 according to an example.

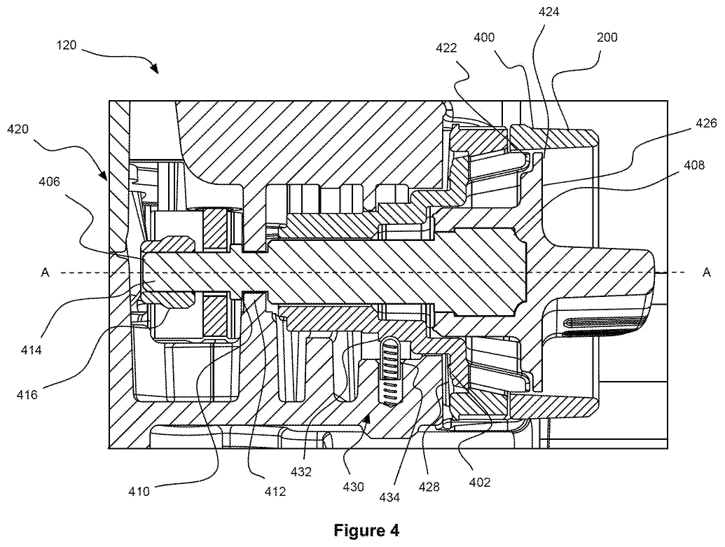

The depth adjustment mechanism 120 comprises a depth adjustment knob 200 and a locking knob 202. Both the depth adjustment knob 200 and the locking knob 202 are rotatable. In some examples, the depth adjustment knob 200 and the locking knob 202 are rotatable about a common rotation axis A-A. The rotation axis A-A is best shown in FIG. 4. FIG. 4 shows a partial cross-sectional side view along the plane B-B as shown in FIG. 2 of the depth adjustment mechanism 120 according to an example.

Rotation of the locking knob 202 about the rotation axis A-A selectively locks and unlocks the depth rod 118. In some examples, rotation of the locking knob 202 about the rotation axis A-A optionally selectively locks and unlocks depth adjustment knob 200. When the locking knob 202 is in the locked position, the depth rod 118 is prevented from moving with respect to the housing 102. When the locking knob 202 is in the locked position, the depth adjustment knob 200 is also prevented from causing movement of the depth rod 118 and the depth stop 122 with respect to the housing 102. In other words, when the locking knob 202 is in the locked position, the depth rod 118 and the depth stop 122 are fixed with respect to the housing 102. In some examples, when the locking knob 202 is in the locked position, the fine depth adjustment mechanism 130 is also prevented from moving the depth rod 118 and the depth stop 122 are fixed with respect to the housing 102. Alternatively, when the locking knob 202 is in the locked position, the fine depth adjustment mechanism 130 is not prevented from moving the depth stop 122 with respect to the housing 102.

In some examples, the locking knob 202 is moveable between the locked position and the unlocked position, by rotating the locking knob 202 about the rotation axis A-A. In some other examples (not shown) the locking knob 202 is slidable (or rotatable and slidable) in a direction along the length of the rotation axis A-A between the locked position and the unlocked position.

The locking knob 202 comprises a projecting gripping surface 204. In some examples the projecting gripping surface 204 extends diametrically across the locking knob 202. In some examples, the projecting gripping surface comprises a curved surface. This makes gripping the locking knob 202 more ergonomic and allows the user to grip one side of the projecting gripping surface 204 with their thumb and another side of the projecting gripping surface 204 with one or more fingers. The projecting gripping surface 204 extends across the rotation axis A-A. This means that the user can increase the turning moment on the locking knob 202 because the user can apply force with their thumb and fingers on different sides of the projecting gripping surface 204. This means that the user can also increase the force they can apply to the locking knob 202 when moving the locking knob 202 between the locked and unlocked positions.

In some examples, the locking knob 202 is at least partially nested within the depth adjustment knob 200. In this way, the depth adjustment knob 200 surrounds the locking knob 202 and the depth adjustment knob 200 is arranged to rotate around the outside of the locking knob 202. As shown in FIG. 2, a portion of the projecting gripping surface 204 extends beyond a depth adjustment knob lip 206. In other examples (not shown), the locking knob 202 is completely nested within the depth adjustment knob 200. This means that the projecting gripping surface 204 of the locking knob 202 does not extend beyond the depth adjustment knob lip 206.

By nesting at least part of the locking knob 202 within the depth adjustment knob 200, both the locking knob 202 and the depth adjustment knob 200 can be increased in size without taking up extra space on the housing 102. Furthermore, by providing a locking knob 202 with a larger diameter means that the user can achieve a greater mechanical advantage when rotating the locking knob 202 between the locked position and the unlocked position. This means it is easier for the user to twist the locking knob 202 and selectively release or secure the depth rod 118 and as a result, the depth adjustment knob 200.

Furthermore, a nested arrangement for the locking knob 202 and depth adjustment knob 200 means that the process of depth setting of the cutting tool and locking the depth adjustment mechanism 120 can be achieved in a single location in a compact, space saving arrangement. This means that the user can unlock and adjust the depth of the cutting tool with a single hand.

FIG. 2 shows that the locking knob 202 is nested within the depth adjustment knob 200. However, in some alternative examples (not shown), the depth adjustment knob 200 can be nested within the locking knob 202. The examples as shown in the FIGS. 1 to 7 are preferred because the user can apply more force to the inner nested locking knob 202. This means that the user can better move the locking knob 202 into the locked position and better secure the depth adjustment knob 200.

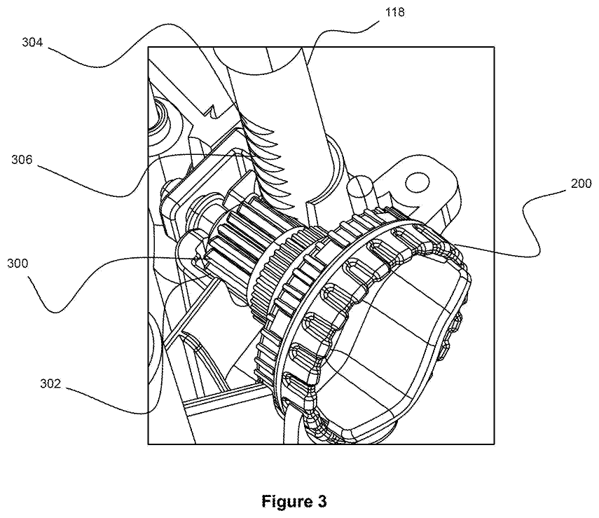

The depth adjustment mechanism 120 will now be discussed in further detail with respect to FIG. 3. FIG. 3 shows a close-up partial cut-away perspective view of the router 100 according to an example. The housing 102 is not shown in FIG. 3 for the purposes of clarity.

The depth adjustment knob 200 is connected to a pinion 300. The pinion 300 is fixed with respect to the depth adjustment knob 200 and is arranged to rotate about the rotation axis A-A. The teeth 302 of the pinion 300 engage grooves 304 in a rack 306 mounted on the depth rod 118. Accordingly, when the depth adjustment knob 200 rotates, the depth rod 118 will move either up or down with respect to the housing 102. In this way, the depth adjustment knob 200 is mechanically coupled to the depth rod 118. Whilst the depth adjustment knob 200 is mechanically coupled to the depth rod 118 via a pinion 300 and a rack 306, any other suitable mechanism can be used to mechanically link the depth adjustment knob 200 to the depth rod 118.

For example, a clockwise rotation of the depth adjustment knob 200 about the rotation axis A-A (as shown in FIG. 3) will cause the depth rod 118 to move away from the base 106. Conversely, an anticlockwise rotation of the depth adjustment knob 200 about the rotation axis A-A (as shown in FIG. 3) will cause the depth rod 118 to move towards the base 106.

As mentioned previously, the depth adjustment knob 200 is rotatable when the locking knob 202 is in the unlocked position. When the locking knob 202 is in the locked position, the depth adjustment knob 200 is fixed and cannot rotate about the rotation axis A-A. Accordingly, the pinion 300 is also fixed and the rack 306 cannot move with respect to the pinion 300. This means the depth rod 118 remains fixed with respect to the housing 102.

Turning back to FIG. 4, the depth adjustment mechanism 120 will be discussed in more detail.

The locking knob 202 is fixed to a rotatable shaft 406 at a first end 408 of the rotatable shaft 406. The locking knob 202 can be fastened to the first end 408 of the rotatable shaft 406. The locking knob 202 additionally or alternatively can be moulded on to the first end 408 of the rotatable shaft 406. In some examples, the locking knob 202 can be integral with the rotatable shaft 406, for example the rotatable shaft 406 and the locking knob 202 are a single unitary element.

The rotatable shaft 406 is configured to rotate about the rotation axis A-A when the locking knob 202 rotates between the locked position and the unlocked position. The rotatable shaft 406 optionally comprises a circumferential groove 410. The circumferential groove 410 receives a housing portion 412. When the housing portion 412 is seated in the circumferential groove 410 as shown in FIG. 4, the rotatable shaft 406 is prevented from moving along the rotation axis A-A with respect to the housing 102.

At a second end 414 of the rotatable shaft 406 the rotatable shaft 406 is coupled to a locking mechanism 420, The locking mechanism 420 optionally comprises a locking nut 416. The second end 414 of the rotatable shaft 406 is threaded and the locking nut 416 is threaded on to the second end 414. Rotation of the locking knob 202 and the rotatable shaft 406 from the unlocked position to the locked position causes the locking nut 416 to tighten on the second end 414. Further discussion of the locking mechanism 420 will be made below.

The depth adjustment knob 200 comprises a hollow cylinder and the walls 400 of the cylinder surround the locking knob 202. The depth adjustment knob 200 comprises a shoulder portion 422 which projects from the walls 400. The shoulder portion 422 is circumferential around the depth adjustment knob 200 and is configured to receive at least a portion of the locking knob 202.

The locking knob 202 comprises a flange 426 with an edge lip 424. The edge lip 424 of the flange 426 is adjacent to the shoulder portion 422. In the unlocked position, the shoulder portion 422 of the depth adjustment knob 200 is spaced from the edge lip 424 and can move with respect to the edge lip 424 of the locking knob 202. In the locked position the locking knob 202 is tightened against the locking nut 416 and the edge lip 424 is urged against the shoulder portion 422.

In the unlocked position, a second shoulder portion 402 of the depth adjustment knob 200 is spaced from and can move with respect to a housing reciprocal surface 428. In the locked position the locking knob 202 is tightened against the locking nut 416 and the second shoulder portion 402 is urged against the housing reciprocal surface 428. Since the second shoulder portion 402 of the depth adjustment knob is pushed against the housing reciprocal surface 428, the friction between the second shoulder portion 402 and the housing reciprocal surface 428 is increased.

In this way, the locking knob 202 exerts a locking force against the depth adjustment knob 200 in the locked position. This means that frictional forces between the shoulder portion 422 and the edge lip 424 and between the second shoulder portion 402 and the housing reciprocal surface 428 are sufficiently high to prevent the user from rotating the depth adjustment knob 200.

In some examples, the locking knob 202 is arranged to move axially along the rotation axis A-A to exert a frictional force against the depth adjustment knob 200 to prevent relative movement of the depth adjustment knob with respect to the housing 102. Additionally, or alternatively, the locking knob 202 comprises one or more locking pins (not shown) projecting from the surface of the locking knob 202 adjacent to the depth adjustment knob 200. The one or more locking pins project into one or more reciprocal recesses (not shown) in the surface of the depth adjustment knob 200 facing the locking knob 202. In the locked position, the locking pins engage the reciprocal recesses and prevent movement of the depth adjustment knob 200. The locking knob 202 can rotate, slide or a combination of both to move between the locked and unlocked positions.

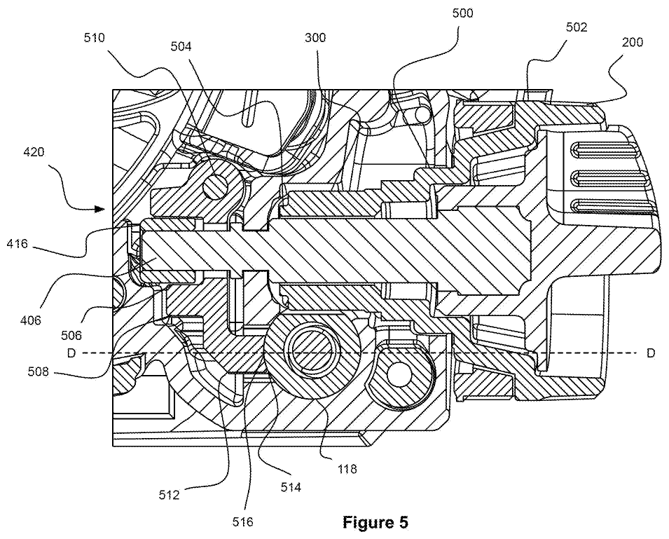

The depth adjustment mechanism 120 and the locking mechanism 420 wi11 be discussed more detail with respect to FIG. 5. FIG. 5 shows a partial cross-sectional plan view along the plane C-C as shown in FIG. 2 of a depth adjustment mechanism according to an example.

The depth adjustment mechanism 120 is the same as shown in the previous Figures. The depth adjustment knob 200 is fixed to a hollow sleeve 500. The hollow sleeve 500 is mounted over the rotatable shaft 406 and arranged to rotate around the axis of rotation A-A.

The depth adjustment knob 200 is fixed to the hollow sleeve 500 at a first end 502 of the rotatable shaft 406. The depth adjustment knob 200 can be fastened to the first end 502 of the hollow sleeve 500. However as shown in FIG. 5, the depth adjustment knob 200 is moulded on to the first end 502 of the hollow sleeve 500. In this way, the depth adjustment knob 200 can be integral with the hollow sleeve 500, for example the hollow sleeve 500 and the depth adjustment knob 200 are a single unitary element. Alternatively, the hollow sleeve 500 and the depth adjustment knob 200 are separate parts and fastened together with e.g., screws.

The pinion 300 is mounted at a second end 504 of the hollow sleeve 500. The pinion 300 can be a separate element fastened to the second end 504 of the hollow sleeve 500. Alternatively, the pinion 300 can also be integral with the hollow sleeve 500. For example, the hollow sleeve 500 and the pinion 300 are a single unitary element.

The locking mechanism 420 will now be described in more detail. The locking nut 416 engages with a recess 506 in a pivotable clamp arm 508. The pivotable clamp arm 508 rotates about pivot 510. The pivotable clamp arm 508 is arranged to move between a clamping position and a release position. FIG. 5 shows the pivotable clamp arm 508 in the clamping position whereby a projecting finger 512 engages with a rod surface 514 of the depth rod 118. In the clamping position, the pivotable clamp arm 508 exerts a clamping force against the rod surface 514 of the depth rod 118.

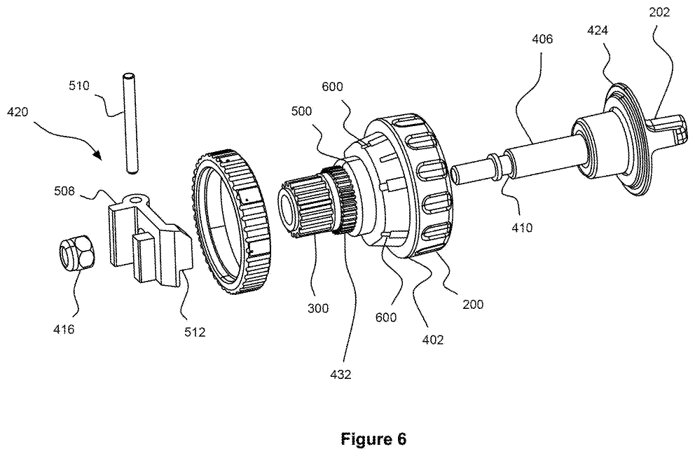

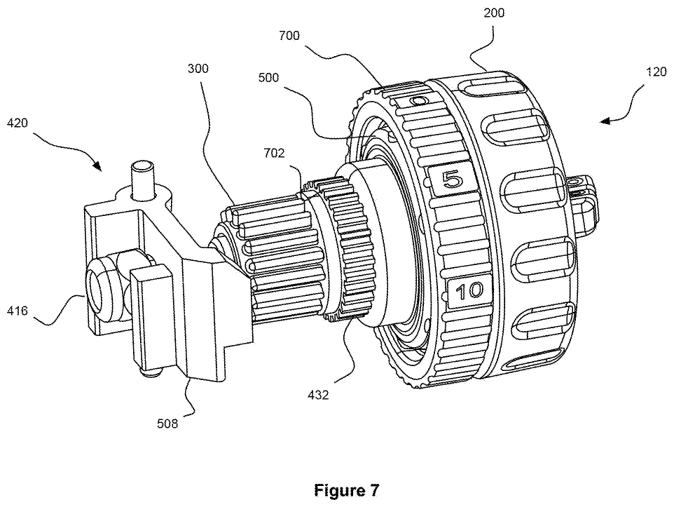

The assembled locking mechanism 420 can be seen in FIG. 7 whereas the disassembled parts of the locking mechanism 420 can be seen in FIG. 6. FIG. 6 shows an exploded perspective view of the depth adjustment mechanism 120 according to an example. FIG. 7 shows a perspective view of the depth adjustment mechanism 120 according to an example. The depth rod 118 has not been shown in FIG. 6 or 7 for the purposes of clarity.

Turning back to FIG. 5, the locking mechanism 420 will be discussed in more detail. The pivotable clamp arm 508 is in the clamping position when the locking knob 202 is in the locked position. As the locking knob 202 is rotated into the locked position, the rotatable shaft 406 tightens in the locking nut 416. The locking nut 416 then exerts a force against the pivotable clamping arm 508 and the pivotable clamping arm 508 pivots into the clamping position and clamps against the depth rod 118.

In some examples, at least a portion of the pivotable clamping arm 508 clamps against the rod surface 514 in a direction towards the longitudinal axis of the depth rod 118, e.g., the centre of the depth rod 118. In some examples the projecting finger 512 comprises a curve surface 516 reciprocal to the curve cylindrical wall of the depth rod 118. By pressing against the depth rod 118 in a direction through the centre of the depth rod 118, the pivotable clamping arm 508 does not exert a turning moment against the depth rod 118.

In some examples, the pivotable clamping arm 508 urges against the depth rod 118 in a direction towards the depth adjustment knob 200 when the locking mechanism 420 is in the locked position. The pivotable clamp arm 508 clamps against the depth rod 118 in a position which is aligned with a position where the depth adjustment knob 200 is urged against the housing 102.

As shown in FIG. 5, the pivotable clamping arm 508 urges against the depth rod 118 in a direction along axis D-D. The centre of the depth rod 118, the point of contact between the projecting finger 512 and the rod surface 514, and a point of contact between the second shoulder portion 402 and the housing reciprocal surface 428 are all aligned along axis D-D. This means that the locking mechanism 420 squeezes the depth adjustment knob 200 against the housing 102 and towards the depth rod 118. By squeezing the depth adjustment knob 200 towards the housing 102, the locking mechanism 420 is more resilient. For example, the locking mechanism 420 does not rely on pushing outwardly against part of the housing 102 which would deform and break the housing 102.

In some alternative examples, the pivotable clamping arm 508 and the locking nut 416 are replaced with an axially moveable clamping arm (not show). Instead, the threaded second end 414 screws into a threaded bore of the axially moveable clamping arm. In this way, when the locking knob 202 is rotated, the rotatable shaft 406 rotates and causes the axially moveable clamping arm to move axially along the rotation axis A-A towards the locking knob 202. In this way the projecting finger 512 is moveable along a direction parallel to the rotation axis A-A when moving between the clamping position and the release position. As the projecting finger 512 moves along a direction parallel to the rotation axis A-A, this causes the axially moveable clamping arm to clamp against the depth rod 118.

In some examples, the depth adjustment mechanism 120 comprises a scale wheel indicator 700 for indicating the distance the cutting tool projects through the base 106. The scale wheel indicator 700 is an annular collar configured to rotatably mounted on the hollow sleeve 500. The scale wheel indicator 700 is rotatable with respect to the hollow sleeve 500 and the depth adjustment knob 200. The scale wheel indicator 700 is rotatable about the rotation axis A-A. This means that the scale wheel indicator 700 can be zeroed by the user when carrying out a depth adjustment operation. The hollow sleeve 500 comprises a plurality of clips 600 for securing the scale wheel indicator 700 in place. The plurality of clips 600 permit the scale wheel indicator 700 rotating with respect to the hollow sleeve 500, but prevent axial movement of the scale wheel indicator 700 along the rotation axis A-A. The housing 102 can optionally comprise a scale mark 208 (as best shown in FIG. 2) for aligning the scale wheel indicator 700.

Another example of the depth adjustment knob 200 will now be discussed in reference to FIG. 4. Optionally, the depth adjustment knob 200 additionally comprises an indexing mechanism 430 configured to index rotation of the depth adjustment knob 200.

The indexing mechanism 430 comprises a circumferential indexing surface 432 mounted on a portion of the hollow sleeve 500. The circumferential indexing surface 432 is best shown in FIGS. 6 and 7. In some examples, the circumferential indexing surface 432 is a plurality of circumferentially spaced teeth defining a plurality of indexing positions therebetween. In other words, each indexing position is a groove 702 between a pair of teeth. One such groove 702 is labelled in FIG. 7.

The indexing mechanism 430 comprises a spring biased pin 434 arranged to engage the circumferential indexing surface 432. The indexing mechanism 430 means that when the user is performing a depth adjustment operation with the depth adjustment knob 200, the depth adjustment knob 200 can be precisely adjusted. The indexing mechanism 430 causes a frictional force on the depth adjustment mechanism 120 and decelerates the rotational speed of the depth adjustment knob 200 when the user rotates the depth adjustment knob 200. In some examples, each indexing position of the circumferential indexing surface 432 corresponds to 1 mm of movement of the depth rod 118. This means that the user can receive a tactile feedback when adjusting the depth rod 118 and easily determine the magnitude of the depth adjustment being performed.

In another example, two or more examples are combined. Features of one example can be combined with features of other examples.

Examples of the present disclosure have been discussed with particular reference to the examples illustrated. However, it will be appreciated that variations and modifications may be made to the examples described within the scope of the disclosure.

1. A power tool comprising:
a housing;
a motor assembly arranged to rotate a cutting tool, the motor being mounted in the housing;
at least one guide post slidably mounted to the housing;
a base fixed to the at least one guide post; and
a depth adjustment mechanism arranged to adjust the distance the cutting tool projects through the base, the depth adjustment mechanism comprises:
a depth rod adjustably mounted to the housing and arranged to engage the base when the housing is plunged towards the base;
a depth adjustment knob mechanically coupled to the depth rod being arranged to move the depth rod with respect to the housing;
a locking knob for selectively locking the depth rod,
wherein one of the depth adjustment knob and the locking knob is at least partially nested within the other of the depth adjustment knob and the locking knob.

2. A power tool according to claim 1, wherein the locking knob is nested within the depth adjustment knob.

3. A power tool according to claim 1, wherein locking knob is mounted on a rotatable shaft.

4. A power tool according to a claim 3, wherein the rotatable shaft is coupled to a locking mechanism moveable between a locked position and an unlocked position.

5. A power tool according to claim 4, wherein the locking mechanism comprises a clamping element arranged to urge against the depth rod in the locked position.

6. A power tool according to claim 5, wherein the clamping element is arranged to urge against the depth rod in a direction towards the locking knob.

7. A power tool according to claim 5, wherein the clamping element is pivotally mounted and arranged to move between a first position engaging the depth rod when the locking mechanism is in the locked position and a second position remote from the depth rod when the locking mechanism is in the unlocked position.

8. A power tool according to claim 3, wherein the depth adjustment knob comprises a sleeve portion mountable on at least a portion of the locking knob.

9. A power tool according to claim 8, wherein the sleeve portion is mountable on the rotatable shaft.

10. A power tool according to claim 8, wherein the sleeve portion comprises a pinion engageable with a reciprocal rack mounted on the depth rod.

11. A power tool according to claim 1, wherein the depth adjustment mechanism comprises a rotatable scale collar.

12. A power tool according to claim 11, wherein the rotatable scale collar is rotatable with respect to the depth adjustment knob.

13. A power tool according to claim 11, wherein the housing comprises a scale mark for aligning with the rotatable scale collar.

14. A power tool according to claim 1, wherein the depth adjustment knob comprises an indexing mechanism configured to index rotation of the depth adjustment knob.

15. A power tool according to claim 14, wherein the indexing mechanism comprises a circumferential indexing surface mounted on a portion of the depth adjustment knob.

16. A power tool according to claim 14, wherein the indexing mechanism comprises a spring biased pin arranged to engage the circumferential indexing surface.

17. A power tool according to claim 1, wherein the power tool is a plunge router.

18. A depth adjustment mechanism for a power tool for adjusting a distance a cutting tool projects through a base of the power tool, the depth adjustment mechanism comprising:
a depth rod adjustably mounted to a housing and arranged to engage the base when the housing is plunged towards the base;
a depth adjustment knob mechanically coupled to the depth rod being arranged to move the depth rod with respect to the housing;
a locking knob for selectively locking the depth rod,
wherein one of the depth adjustment knob and the locking knob is at least partially nested within the other of the depth adjustment knob and the locking knob.

19. A power tool comprising:
a housing;
a motor assembly arranged to rotate a cutting tool, the motor being mounted in the housing;
at least one guide post slidably mounted to the housing;
a base fixed to the at least one guide post; and
a depth adjustment mechanism arranged to adjust the distance the cutting tool projects through the base, the depth adjustment mechanism comprises:
a depth rod adjustably mounted to the housing and arranged to engage the base when the housing is plunged towards the base;
a depth adjustment knob mechanically coupled to the depth rod being arranged to move the depth rod with respect to the housing;
a locking mechanism moveable between a locked position and an unlocked position for selectively locking the depth rod,
wherein the locking mechanism comprises a clamping element configured to clamp against the depth rod when the locking mechanism is in the locked position.

20. A power tool according to claim 19, wherein the clamping element urges against the depth rod in a direction towards the depth adjustment knob when the locking mechanism is in the locked position.
